(19) United States
(12) Patent Application Publication
(10) Pub. No.: US 2017/0262169 A1
(43) Pub. Date: Sep. 14, 2017

(54) ELECTRONIC DEVICE FOR GUIDING GESTURE AND METHOD OF GUIDING GESTURE

(71) Applicant: SAMSUNG ELECTRONICS CO., LTD., Suwon-si (KR)

(72) Inventors: Jin-sun KIM, Seoul (KR); Sun-rock LEE, Cheonan-si (KR)

(21) Appl. No.: 15/423,748

(22) Filed: Feb. 3, 2017

(30) Foreign Application Priority Data
Mar. 8, 2016 (KR) 10-2016-0027707

(51) Int. Cl. G06F 3/0488; G06F 3/0346; G06F 3/0481; G06F 3/0354

(52) U.S. Cl. CPC G06F 3/04883; G06F 3/03545; G06F 3/0346; G06F 3/0481

(57) ABSTRACT

A method of guiding a gesture in an electronic device is provided. The method includes sensing a gesture input via an input tool on a screen; predicting a first proceeding direction of the gesture based on information about the gesture; determining a first guide object corresponding to the predicted first proceeding direction; predicting a second proceeding direction of the gesture based on information about a changed gesture when a proceeding direction of the gesture is changed; and determining a second guide object different from the first guide object and corresponding to the predicted second proceeding direction.

### CROSS-REFERENCE TO RELATED APPLICATION

This application is based on and claims priority under 35 U.S.C. §119 to Korean Patent Application No. 10-2016-0027707, filed on Mar. 8, 2016, in the Korean Intellectual Property Office, the disclosure of which is incorporated by reference herein in its entirety.

### BACKGROUND

1. Field

The present disclosure relates generally to electronic devices for guiding gestures and methods of guiding gestures therein, and for example, to methods of providing guidance with respect to a gesture using information about a sensed gesture.

2. Description of Related Art

A user is able to perform various kinds of gestures (e.g., a touch gesture, a touch and drag gesture, and a hovering gesture) with respect to a screen of an electronic device.

Recently, as screens of electronic devices have increased in size, the user may make a gesture on a large-sized screen. For example, in a case of an electronic blackboard that belongs to a display category referred to as a large format display (LFD), a user may touch a surface of the electronic blackboard with an input device to write down contents.

As screens become larger, it is necessary to maintain a shape of such screens and provide a constant pressurization experience according to gestures. To do this, a cover panel (e.g., cover glass) on which a gesture is performed may have a thickness of a predetermined value or greater, and there may be an additional air layer between a display panel and the cover panel.

Also, as screens becomes larger, a distance between a surface on which a user gesture is performed and a display panel providing a graphic object according to the user gesture may increase. In this case, the user may experience as if an input device used to perform a gesture floats on a plane in which the graphic object is drawn.

In particular, the farther the user's eyes get from the graphic object, the worse an eccentric effect as described above may become.

### SUMMARY

A gesture guidance for providing a user with a feeling of contact, so that the user feels as if he/she is in contact with a drawn graphic object is provided.

Additional aspects will be set forth in part in the description which follows and, in part, will be apparent from the description.

According to an aspect of an example embodiment, a method of guiding a gesture in an electronic device is provided, the method includes: sensing a gesture input via an input tool; predicting a first proceeding direction of the gesture based on information about the gesture; determining a first guide object corresponding to the predicted first proceeding direction; when a proceeding direction of the gesture is changed, predicting a second proceeding direction of the gesture based on information about the changed gesture; and determining a second guide object different from the first guide object, the second guide object corresponding to the predicted second proceeding direction.

According to an aspect of an example embodiment, a method of guiding a gesture in an electronic device is provided, the method includes: sensing a gesture input via an input tool; predicting a first proceeding direction of the gesture based on information about the gesture; determining a first guide object corresponding to the predicted first proceeding direction; and when a graphic object based on the gesture is adjacent to a previously represented graphic object, determining a second guide object different from the first guide object.

According to an aspect of an example embodiment, an electronic device for guiding a gesture is provided, the electronic device includes: a display configured to provide a screen; a memory configured to store a first guide object and a second guide object different from the first guide object; a touch panel configured to sense a gesture input via an input tool; and a controller configured to control the display to represent a graphic object based on the gesture, to determine the first guide object corresponding to a predicted first proceeding direction of the gesture, the predicted first proceeding direction being predicted based on information about the gesture, and when a proceeding direction of the gesture is changed, to determine a second guide object corresponding to a predicted second proceeding direction of the gesture, the predicted second proceeding direction being predicted based on information about the changed gesture.

According to an aspect of an example embodiment, an electronic device for guiding a gesture is provided, the electronic device includes: a display configured to provide a screen; a memory configured to store a first guide object and a second guide object different from the first guide object; a touch panel configured to sense a gesture input via an input tool; and a controller configured to control the display to represent a graphic object based on the gesture, to determine the first guide object corresponding to a predicted first proceeding direction of the gesture, the predicted first proceeding direction being predicted based on information about the gesture, and when the graphic object based on the gesture is adjacent to a previously represented graphic object, to determine a second guide object different from the first guide object.

According to an aspect of an example embodiment, a non-transitory computer readable recording medium having embodied thereon a program, which when executed by a computer, performs operations of a method including: predicting a first proceeding direction of a gesture, based on information about the gesture input via an input tool; determining a first guide object corresponding to the predicted first proceeding direction; when a proceeding direction of the gesture is changed, predicting a second proceeding direction of the gesture based on information about the changed gesture; and determining a second guide object corresponding to the predicted second proceeding direction different from the first guide object.

According to an aspect of an example embodiment, a non-transitory computer readable recording medium having embodied thereon a program, which when executed by a computer, performs operations of a method including: sensing a gesture input via an input tool; predicting a first proceeding direction of the gesture based on information about the gesture; determining a first guide object corresponding to the predicted first proceeding direction; and when a graphic object based on the gesture is adjacent to a previously represented graphic object, determining a second guide object different from the first guide object.

### BRIEF DESCRIPTION OF THE DRAWINGS

These and/or other aspects, features and attendant advantages of the present disclosure will become apparent and more readily appreciated from the following detailed description, taken in conjunction with the accompanying drawings, in which like reference numerals refer to like elements, and wherein:

FIGS. 1A, 1B and 1C are diagrams illustrating example types of use of an electronic device according to an example embodiment;

FIG. 2 is a block diagram illustrating an example electronic device according to an example embodiment;

FIGS. 3A and 3B are diagrams illustrating partial cross-sectional views of an example electronic device;

FIGS. 4A, 4B, 4C, 5A, 5B, 6A, 6B, 7A and 7B are diagrams illustrating example guidance of a user gesture, according to an example embodiment;

FIGS. 8A, 8B, 8C, 9A, 9B and 9C are diagrams illustrating examples of switching of a function being executed by an electronic device, according to an example embodiment; and

FIGS. 10 and 11 are flowcharts illustrating an example method of providing gesture guidance, according to an example embodiment.

### DETAILED DESCRIPTION

Hereinafter, various example embodiments of the present disclosure will be described below with reference to accompanying drawings. However, this is not intended to limit the present disclosure to particular modes of practice, and it is to be appreciated that all modifications, equivalents, and/or alternatives that do not depart from the spirit and technical scope are encompassed in the disclosure. Like reference numerals denote the same elements.

In the present disclosure, it is to be understood that terms such as “including”, “having”, etc., are intended to indicate the existence of the features (for example, numbers, operations, or components, such as parts), and are not intended to preclude the possibility that one or more other features may exist or may be added.

As used in the present disclosure, the terms “A or B,” “at least one of A and/or B,” and “one or more of A and/or B” may include any one of listed items and all of at least one combination of the items. For example, “A or B,” “at least one of A and B,” or “at least one of A or B” may include (1) at least one A, (2) at least one B, or (3) at least one A and at least one B.

While such terms as “first”, “second”, etc., may be used to describe various components, such components must not be limited to the above terms. The above terms are used only to distinguish one component from another. For example, a first user device and a second user device may indicate different user devices regardless of an order or an importance. For example, a first component may be named a second component, and similarly, a second component may be named a first component without departing from the scope of the present disclosure.

When a component (first component) is “operatively or communicatively coupled with/to” or “connected to” another component (second component), the first component may be connected to the second component directly or through another component (third component). On the other hand, when the first component is “directly coupled with/to” or “directly connected to” the second component, no other component exists between the first and second components.

The expression “configured to (or set to)” used in the present disclosure may be used interchangeably with, for example, “suitable for”, “having the capacity to”, “designed to”, “adapted to”, “made to”, or “capable of”, according to situations. The expression “configured to (or set to)” may not only necessarily refer to “specifically designed to” in terms of hardware. Instead, in some situations, the expression “device configured to” may refer to a situation in which the device is “capable of” together with another device or parts. For example, the phrase “a processor configured to (or set to) perform A, B, and C” may be a dedicated processor (for example, an embedded processor) for performing A, B, and C, or a generic-purpose processor (for example, a central processing unit (CPU) or an application processor (AP)) for performing A, B, and C by executing at least one software program stored in a memory device.

The terms used in the present disclosure are merely used to describe particular example embodiments, and are not intended to limit the present disclosure. An expression used in the singular encompasses the expression in the plural, unless it has a clearly different meaning in the context. Unless otherwise defined, all terms (including technical and scientific terms) used herein have the same meanings as commonly understood by one of ordinary skill in the art to which this disclosure belongs. It will be further understood that terms such as those defined in commonly used dictionaries should be interpreted as having meanings that are consistent with their meanings in the context of the relevant art and will not be interpreted in an idealized or overly formal sense unless expressly so defined herein.

An electronic device according to some embodiments may include at least one of, for example, a smart phone, a tablet personal computer (PC), a mobile phone, a video phone, an e-book reader, a desktop PC, a laptop PC, a netbook computer, a workstation, a server, a personal digital assistant (PDA), a portable multimedia player (PDP), an MP3 player, a mobile medical device, a camera, and a wearable device, or the like, but is not limited thereto. According to some embodiments, the wearable device may include at least one of an accessory-type wearable device (for example, a watch, a ring, a bracelet, an ankle bracelet, a necklace, glasses, a contact lens, or a head-mounted device (HMD)), a fabric- or clothing-integrated type wearable device (for example, an electronic dress), a body-attached type wearable device (for example, a skin pad or a tattoo), and a body implanted type wearable device (for example, an implantable circuit), or the like, but is not limited thereto.

In some embodiments, the electronic device may be a home appliance. The home appliance may include at least one of, for example, a television (TV), a digital video disk (DVD) player, an audio player, a refrigerator, an air conditioner, a vacuum cleaner, an oven, a microwave, a washing machine, an air cleaner, a set-top box, a home automation control panel, a security control panel, a TV box (for example, Samsung HomeSync™), a game console, an electronic dictionary, an electronic key, a camcorder, and an electronic picture frame, or the like, but is not limited thereto.

According to other embodiments, the electronic device may include at least one of various medical devices (for example, various portable medical measuring devices (a blood sugar measuring device, a heartbeat measuring device, a blood pressure measuring device, and a thermometer), magnetic resonance angiography (MRA), magnetic resonance imaging (MRI), computed tomography (CT), and an ultrasonic machine), a navigation device, a global navigation satellite system (GNSS), an event data recorder (EDR), a flight data recorder (FDR), a vehicle infotainment device, a marine electronic device (for example, marine navigation equipment or a gyro compass), avionics, a security device, a vehicle head unit, industrial or home robots, automatic teller's machine, point of sales (POS), and Internet of things (for example, a bulb, various sensors, an electric or gas meter, a sprinkler, a fire alarm, a thermostat, a streetlight, a toaster, sports goods, a hot water tank, a heater, and a boiler), or the like, but is not limited thereto.

According to some embodiments, the electronic device may be a watch type wearable device. According to various embodiments, the electronic device may be a watch type wearable device including a rotor.

Hereinafter, an electronic device according to various embodiments will be described with reference to accompanying drawings. In this disclosure, a user may denote a person using an electronic device or an apparatus using an electronic device (e.g., an artificial intelligence electronic device).

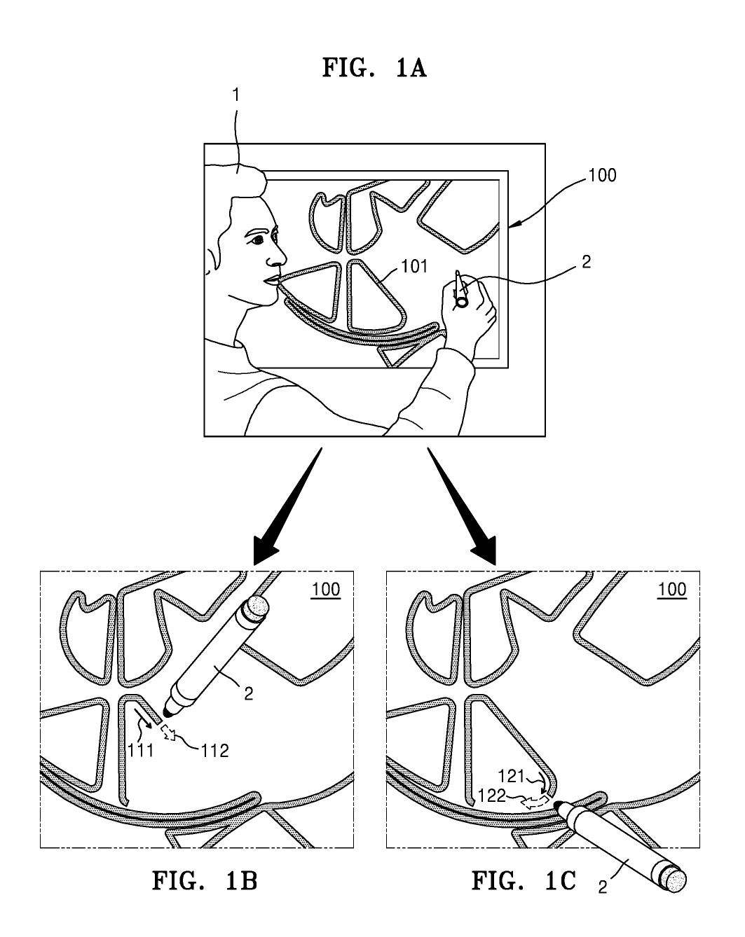

FIGS. 1A, 1B and 1C are diagrams illustrating example types of use of an electronic device 100, according to an example embodiment.

The electronic device 100 may be, for example, an electronic blackboard. In FIG. 1A, the electronic device 100 may be hung on a wall. Otherwise, the electronic device 100 may be supported by the wall or a cradle, or may be fixed by a wire installed on a ceiling.

A user 1 may perform a gesture on a screen of the electronic device 100 using an input tool 2 (e.g., a part of a human body, a touch pen, etc.). The gesture may include, e.g., a hovering gesture, a touch gesture, a drag gesture, etc. Here, the hovering gesture may denote a gesture at a proximate distance without directly touching the electronic device 100. In addition, the drag gesture is a gesture of moving while maintaining a touch state after touching the electronic device 100, and may include a flick gesture or a swipe gesture.

The user 1 may touch a cover panel (e.g., a glass panel) using the input tool 2 and drag the input tool in a certain direction. According to the gesture of the user 1, the electronic device 100 may represent or generate a graphic object 101 at a region corresponding to the gesture. The graphic object 101 may be, for example, a line for coloring or erasing a certain color or a surface.

In this case, due to a thickness of the cover panel or a thickness of an air layer between the cover panel and a display panel, the graphic object 101 may be represented on a region not intended by the user. In particular, as a distance between a height of the user's eyes and a height of the graphic object 101 that is being drawn increases, an eccentric effect felt by the user may worsen.

Accordingly, the electronic device 100 may provide information for guiding the gesture of the user.

As an embodiment, in FIG. 1B, the electronic device 100 may sense the gesture input by using the input tool 2 on the screen.

The electronic device 100 may predict a first proceeding direction 111 of the gesture, based on information about the sensed gesture. The information of the gesture may include, for example, a velocity of the gesture, a trace of the gesture, and inclination degree or inclination direction of the input tool 2 performing the gesture.

The electronic device 100 may determine a first guide object 112 corresponding to the predicted first proceeding direction 111. For example, if the first proceeding direction 111 is a moving straight direction, the first guide object 112 may be an arrow having a tail with a straight line shape.

The electronic device 100 may represent the first guide object 112 on a region corresponding to the predicted first proceeding direction 111. The region corresponding to the predicted first proceeding direction 111 may be a region adjacent to a graphic object in the first proceeding direction 111, in a case where the graphic object according to the gesture is previously represented on the screen. In this case, the region adjacent to the graphic object may include a region contacting the graphic object or spaced apart from the graphic object by a slight distance (e.g., 0.5 mm or less).

In a state where the user performs the gesture by referring to the guide object 112, a proceeding direction of the gesture may be changed as illustrated in FIG. 1C. In FIG. 1C, the changed proceeding direction of the gesture may be, for example, a curved movement direction.

The electronic device 100 may predict a second proceeding direction 121 of the gesture, based in information about the changed gesture.

The electronic device 100 may determine a second guide object 122 corresponding to the second proceeding direction 121 that is predicted. For example, if the second proceeding direction 121 is a curved movement direction, the second guide object 122 may be an arrow having a tail with an arc shape.

The electronic device 100 may represent the second guide object 122 on a region corresponding to the predicted second proceeding direction 121. The region corresponding to the second proceeding direction 121 may be a region adjacent to a graphic object previously represented in the second proceeding direction 121.

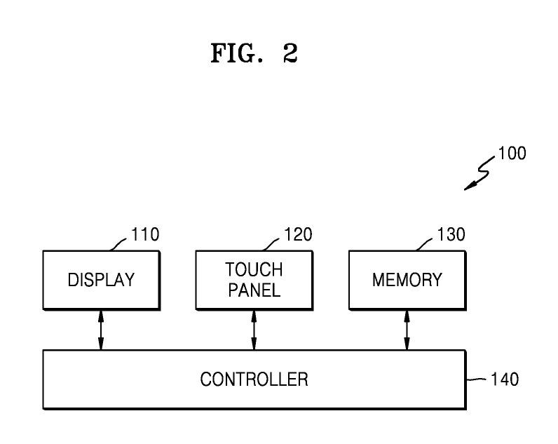

FIG. 2 is a block diagram illustrating an example electronic device 100 according to an example embodiment.

Referring to FIG. 2, the electronic device 100 in the form of an electronic blackboard may include a display 110, a touch panel 120, a memory 130, and a controller (e.g., including processing circuitry) 140.

The display 110 may provide a screen operating under the control of the controller 140. For example, the display 110 may provide a screen for setting and executing functions of the electronic device 100. For example, the display 110 may provide a screen including at least one of a main screen, an application icon, an application execution window, a tool bar menu, a setting menu, a canvas for drawing, and a graphic object.

The display 110 may be implemented by using various display panels. For example, the display 110 may include various panels such as a liquid crystal display (LCD) panel, a plasma display panel (PDP), an organic light-emitting diode (OLED), a vacuum fluorescent display (VFD), a field emission display (FED), and an electro luminescence display (ELD), or the like, but is not limited thereto. In addition, the display 110 may be a flexible display that may be curved, or a three-dimensional (3D) display representing a graphic object three-dimensionally to a user using glasses or without glasses, but is not limited thereto.

The touch panel 120 may be configured to sense a gesture of a user (e.g., a touch gesture) based on an operation of a finger or a touch pen (e.g., a stylus pen or a digitizer pen) on the screen. The touch panel 120 may operate as at least one of an electromagnetic induction type, an infrared ray type, a camera type, and an ultrasound type, or the like, but is not limited thereto. In addition, the touch panel 120 may further include a control circuit. The touch panel 120 may further include a tactile layer for providing the user with a tactile reaction.

In addition, in a case where the touch panel 110 includes an additional pen recognition panel (not shown), the pen recognition panel may sense the gesture according to the operation of the touch pen. The pen recognition panel may be implemented as, for example, an electro-magnetic resonance (EMR) type, and may sense the gesture made by using the touch pen according to a variation in an intensity of an electromagnetic field depending upon a touch or proximity of the pen.

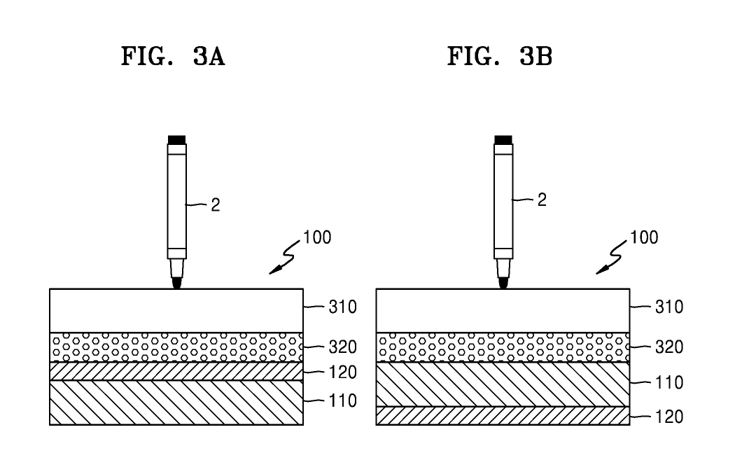

The display panel 110 and the touch panel 120 may be stacked on each other, with an air gap interposed therebetween. FIGS. 3A and 3B are partial cross-sectional views of the electronic device 100. The electronic device 100 may be an electronic blackboard. Referring to FIG. 3A, the electronic device 100 may include a cover panel 310, an air layer 320, the touch panel 120, and the display 110 stacked in the stated order. Otherwise, as illustrated in FIG. 3B, the electronic device 100 may include the cover panel 310, the air layer 320, the display 110, and the touch panel 120 stacked in the stated order. However, FIGS. 3A and 3B are just examples illustrating example stack structures of the electronic device 100, and the components may be stacked in various other orders according to their implementation.

In this case, due to a thickness of the cover panel 310 (e.g., 2.5 mm to 3.5 mm) or a thickness of the air layer 320 (e.g., 3.0 mm to 8.0 mm), the graphic object may be represented on a different region from an intended region of the user. For example, if the user performs a touch and drag gesture on the cover panel 310, a graphic object corresponding to the gesture of the user may be represented on the display 110 disposed under the cover panel 310 and the air layer 320. In this case, as eyes of the user look away from the graphic object, the user may feel as if the graphic object is represented on a region not intended by the user. Accordingly, a guide object according to the present disclosure may be provided in order to reduce an eccentric effect that the user may experience.

Referring back to FIG. 2, the memory 130 may include a volatile and/or non-volatile memory. The memory 130 may store commands or data related to at least one different component of the electronic device 100. According to an example embodiment, the memory 130 may store software and/or a program for executing the embodiments according to the present disclosure. The program may include at least one of a kernel, middleware, an application programming interface, and an application program (or application).

The memory 130 may store the guide object according to the present embodiment. The memory 130 may store various kinds of guide objects mapping to the proceeding direction of the gesture or functions of the electronic device 100. For example, if the proceeding direction is straight, the guide object mapping in the straight direction may be a straight line. In addition, if the proceeding direction of the gesture is curved, the guide object mapping in the curved direction may have a curved shape.

The guide object may be implemented having various shapes, for example, an arrow, a shadow of the graphic object, a circle, and a cross shape, but is not limited thereto. Also, the guide object may flicker, have a different color (e.g., a complementary color) from that of the background, or have a different brightness from and the same color as those of the background, so as to be easily identified by the user.

The controller 140 may include various processing circuitry configured to control overall components in the electronic device 100. In detail, when the electronic device 100 is an electronic blackboard, the controller 140 may control each of the components for performing functions of the electronic blackboard, e.g., playing of content, writing on the blackboard, drawing, editing, and setting.

As an embodiment, when a gesture is sensed through the touch panel 120, the controller 140 may predict a first proceeding direction of the gesture based on information about the gesture. In addition, the controller 140 may determine a first guide object corresponding to the first proceeding direction of the gesture. The controller 140 may control the display 110 so that the first guide object may be represented on a region corresponding to the first proceeding direction. Accordingly, the display 110 may represent the first guide object on the region corresponding to the first proceeding direction.

In addition, the proceeding direction of the gesture may be changed. For example, the gesture may stop or may proceed forming a curve from the straight line.

In this case, the controller 140 may predict a changed proceeding direction of the gesture based on information of changed gesture. In addition, the controller 140 may determine a second guide object corresponding to a second proceeding direction.

Here, the information about the gesture may include, for example, at least one of a velocity of the gesture, a trace of the gesture, an inclination degree of the input tool used to perform the gesture, and an inclined direction of the input tool.

In addition, the controller 140 may control the display 110 so that the second guide object may be represented on a region corresponding to the second proceeding direction that is predicted. Accordingly, the display 110 may represent the second guide object on the region corresponding to the second proceeding direction. In this case, the display 110 may represent the second guide object on a region adjacent to the graphic object that is previously represented according to the gesture in the second proceeding direction.

Hereinafter, various embodiments of guiding the user's gesture on the electronic device 100 including the above-described components will be described.

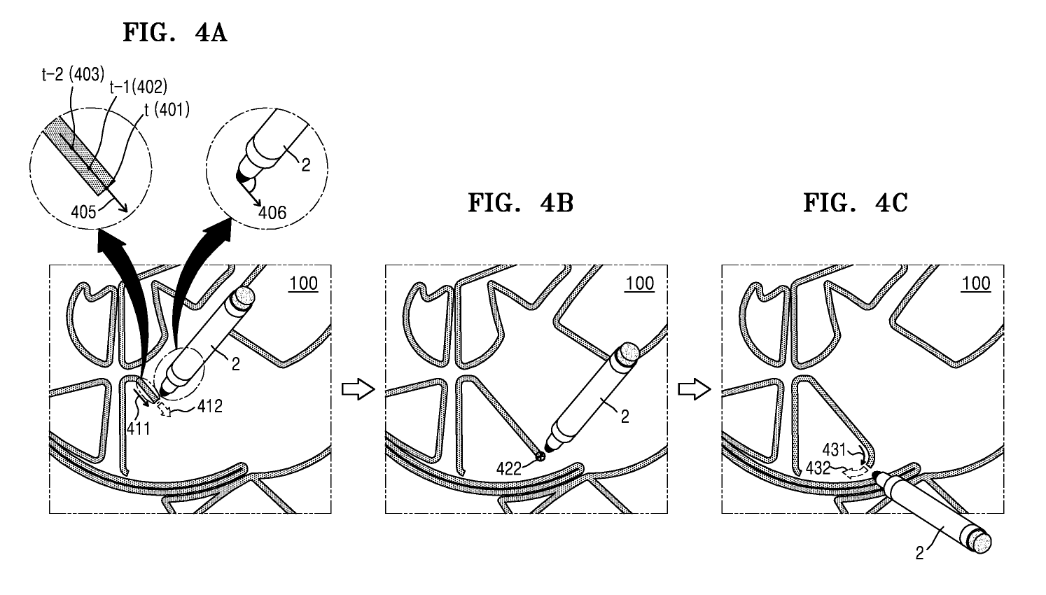

FIGS. 4A, 4B, 4C, 5A, 5B, 6A, 6B, 7A and 7B are diagrams illustrating examples of guiding the user's gesture, according to an example embodiment.

Referring to FIGS. 4A, 4B and 4C, the user may perform a gesture of drawing on a screen using an input tool on the electronic device 100.

In this case, in FIG. 4A, the electronic device 100 may sense the gesture of the user, and may predict a first proceeding direction 411 of the gesture based on information about the sensed gesture.

For example, the electronic device 100 may use a moving trace of a touched location as the information about the sensed gesture. The moving trace of the touched location may include, for example, a touched location 403 at a time point t-2, a touched location 402 at a time point t-1, and a touched location 401 at a time point t. Next, the electronic device 100 may determine a direction 405, to which an extension line connecting the touched locations 401, 402, and 403 to one another proceeds, as a proceeding direction of the gesture.

As another example, the electronic device 100 may use an inclination of the input tool 2 used to perform the gesture as information about the sensed gesture. The input tool 2 may determine an inclination direction 406 of the input tool 2 by using a gyro sensor or an acceleration sensor built in the input tool 2, and may transfer information about the inclination direction 406 to the electronic device 100. The electronic device 100 may determine the inclination direction 406 transmitted from the input tool 2 as a proceeding direction of the gesture.

The electronic device 100 may determine a first guide object 412 corresponding to the first proceeding direction 411. If a direction that the extension line is heading is a straight direction, the electronic device 100 may determine an arrow with a straight tail as the first guide object 412.

The electronic device 100 may represent the first guide object 412 on a region corresponding to the first proceeding direction 411 that is predicted. For example, the electronic device 100 may predict the region where the graphic object is to be represented based on the first proceeding direction 411 in which the gesture moves and a velocity of the gesture determined from the touched locations according to time. In addition, the electronic device 100 may represent the first guide object 412 on the predicted region where the graphic object is to be represented. In this case, the region where the first guide object 412 is to be represented may be a region adjacent to the graphic object that is previously represented in the first proceeding direction 411.

In a state where the user performs the gesture with reference to the guide object 412, the proceeding direction of the gesture may be changed as illustrated in FIG. 4B. In FIG. 4B, a case in which the proceeding direction of the gesture is changed may include stopping of the gesture.

The electronic device 100 may predict a second proceeding direction of the gesture based on information about the changed gesture. For example, when there is no change in the touched location for a predetermined of time (e.g., 1 second or longer), the electronic device 100 may determine a stopped state, in which the second proceeding direction is heading for a center thereof.

The electronic device 100 may determine a second guide object 422 corresponding to the second proceeding direction that is predicted. If the second proceeding direction is stopped, it is difficult to predict the proceeding direction of the gesture afterwards, and thus, the electronic device 100 may determine an object heading omni-directionally or an object having no directionality (e.g., circular shape or cross shape object) as the second guide object 422.

The electronic device 100 may represent the second guide object 422 on a region corresponding to the second proceeding direction. For example, the electronic device 100 may represent the second guide object 422 at an end portion of the graphic object that is previously represented.

In this status, as illustrated in FIG. 4C, the proceeding direction of the gesture is changed again. In FIG. 4C, the changed proceeding direction of the gesture may be a curved direction.

The electronic device 100 may predict a third proceeding direction 431 of the gesture based on information about the changed gesture. For example, as illustrated above with reference to FIG. 4A, the electronic device 100 may predict a direction that the extension line connecting the touched locations based on the trace of the touched locations is heading as the third proceeding direction 431.

Next, the electronic device 100 may determine a third guide object 432 corresponding to the third proceeding direction 431. If the extension line proceeds in a curved manner, the electronic device 100 may determine an arrow with an arc-shaped tail as the third guide object 432.

The electronic device 100 may represent the third guide object 432 on a region corresponding to the third proceeding direction 431. For example, if a curved graphic object according to the gesture is previously represented on the screen, the electronic device 100 may represent the third guide object 432 on a region adjacent to the previously represented graphic object in the third proceeding direction 431.

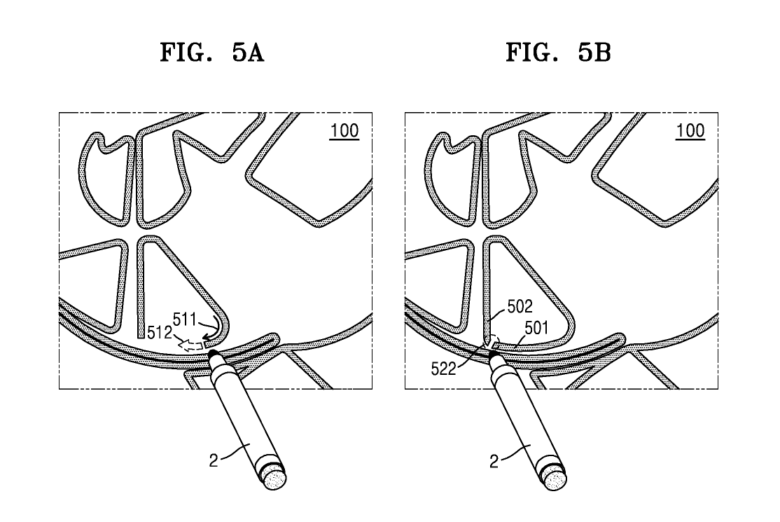

FIGS. 5A and 5B are diagrams illustrating examples of guiding a gesture of a user, according to an example embodiment.

Referring to FIGS. 5A and 5B, the user may perform a gesture that draws a closed loop on the screen using an input tool.

In FIG. 5A, the electronic device 100 may sense the gesture of the user, and may predict a first proceeding direction 511 of the gesture based on information about the sensed gesture.

The electronic device 100 may determine a first guide object 512 corresponding to the first proceeding direction 511. If the extension line proceeds in a curved manner, the electronic device 100 may determine an arrow with an arc-shaped tail as the first guide object 512.

The electronic device 100 may represent the first guide object 512 on a region corresponding to the first proceeding direction 511.

In this circumstance, as illustrated in FIG. 5B, a graphic object 501 that is newly drawn according to the gesture may be adjacent to the graphic object 502 previously represented within a predetermined distance (e.g., 5 mm or less). In this case, the electronic device 100 may determine a circular shaped object as a second guide object 522 for representing that the graphic object makes a closed loop.

The electronic device 100 may represent the second guide object 522 on the screen. For example, the electronic device 100 may represent at least a part of the second guide object 522 on a region between the graphic object 501 that is newly drawn according to the gesture and the previously represented graphic object 502.

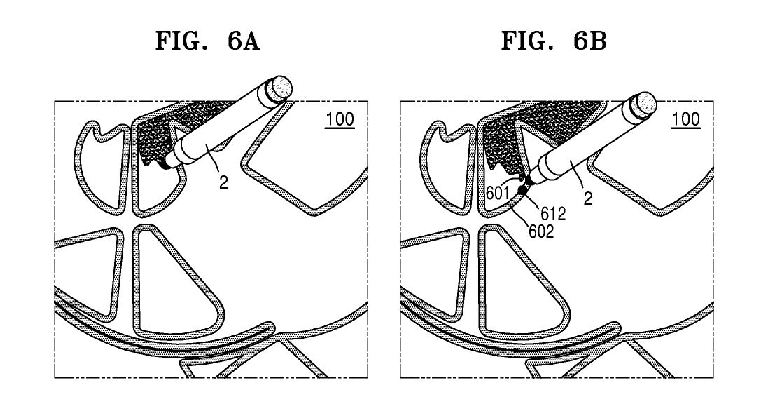

FIGS. 6A and 6B are diagrams illustrating examples of guiding a gesture of a user, according to an example embodiment.

Referring to FIG. 6A, the user may perform a gesture that colors inside a closed loop on a screen. The electronic device 100 may sense the gesture of the user, and may represent a color in the closed loop according to the sensed gesture.

In this circumstance, as illustrated in FIG. 6B, a graphic object 601 that is newly drawn according to the gesture may be adjacent to a closed loop 602 within a predetermined distance (e.g., 5 mm or less).

When the graphic object 601 is adjacent to the closed loop 602 within a predetermined distance, the electronic device 100 may determine a circular shaped object as a guide object 612 in order to notify the user that the graphic object 601 that is newly drawn according to the gesture may escape from the closed loop 602. A color of the guide object 612 may be determined based on the color inside the closed loop. For example, the color of the guide object 612 may be the same as or darker than the color inside the closed loop, but is not limited thereto.

The electronic device 100 may represent the guide object 612 on the screen. For example, the electronic device 100 may represent the guide object 612 on the closed loop 602 or a region adjacent to the closed loop 602.

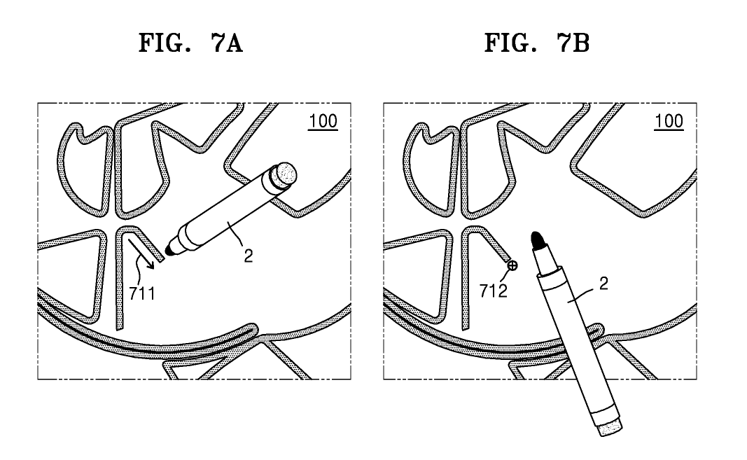

FIGS. 7A and 7B are diagrams illustrating examples of guiding a gesture of a user, according to an example embodiment.

Referring to FIG. 7A, the user may perform a touch and drag gesture that draws on the screen by using the input tool 2. The electronic device 100 may sense the touch and drag gesture of the user, and may represent a graphic object according to the sensed touch and drag gesture.

In this circumstance, as illustrated in FIG. 7B, the user may perform a touch suspension gesture that suspends the touch gesture drawing on the screen.

The electronic device 100 may sense the touch suspension gesture of the user, and may determine a cross shape or circular shape object as a guide object 712 for representing that the touch gesture has been suspended.

The electronic device 100 may represent the guide object 712 on a determined region based on information about the touch and drag gesture that is previously performed. For example, the electronic device 100 determines the region where the guide object 712 is to be represented based on the proceeding direction 711 of the touch and drag gesture that is previously performed and a velocity of the touch and drag gesture, and may represent the guide object 712 on the determined region.

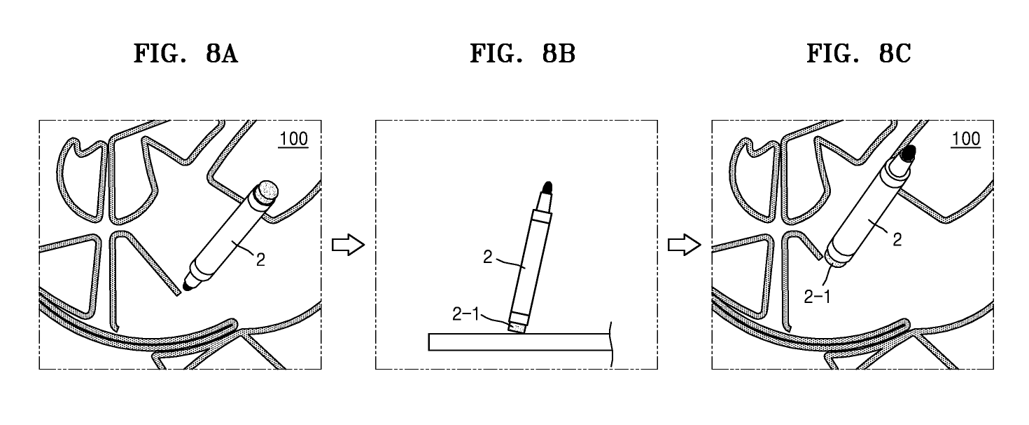

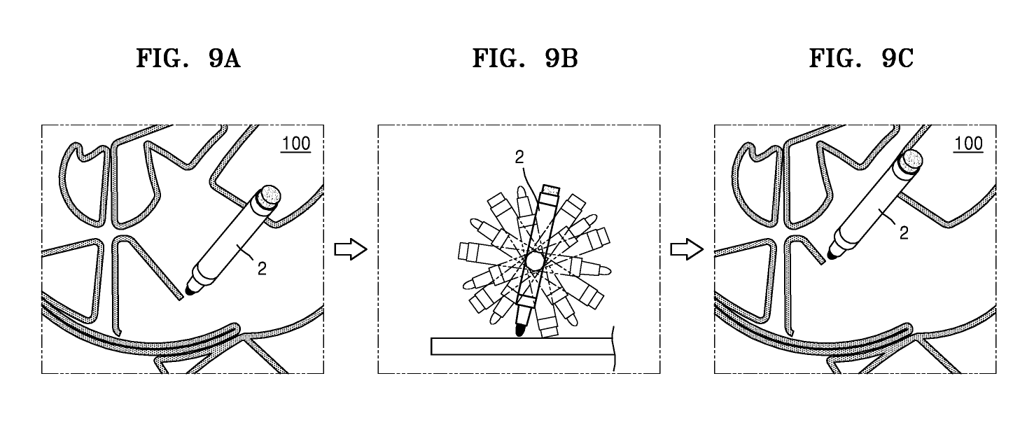

FIGS. 8A, 8B, 8C, 9A, 9B and 9C are diagrams illustrating examples of switching of a function being executed by the electronic device 100, according to an example embodiment.

Referring to FIG. 8A, the user may perform a gesture that draws on the screen using the input tool 2. The electronic device 100 may sense the gesture of the user, and may represent a graphic object according to the sensed gesture.

In this circumstance, if the user wants to execute another function, as illustrated in FIG. 8B, the user may perform the gesture by turning over the input tool 2 so that an end portion 2-1 of the input tool 2 may face the screen. Accordingly, the input tool 2 determines an inclination angle of the input tool 2 using a gyro sensor or an acceleration sensor built in the input tool 2, and may transfer information about the inclination angle to the electronic device 100. Otherwise, the input tool 2 determines that the input tool 2 is turned over based on the determined inclination angle, and may transfer status information of the input tool 2 to the electronic device 100.

When it is determined that the input tool 2 is turned over, the electronic device 100 may switch a function that is currently being executed in relation to the input tool 2 to another function. For example, in a case where a drawing function is being executed, the electronic device 100 may automatically switch to an opposite function of the drawing function, e.g., an erase function. Also, in a case where a line drawing function is being executed, the electronic device 100 may automatically switch to an expanded function, e.g., a surface fill function.

As illustrated in FIG. 8C, the user may perform a gesture on the screen using the end portion 2-1 of the input tool 2. The electronic device 100 may sense the gesture input by the end portion 2-1 of the input tool 2, and may execute another function that is automatically switched based on the sensed gesture. For example, the electronic device 100 may perform an erase function to delete the graphic object that is previously drawn on the screen.

In this case, a detailed function of the switched function may be changed according to an inclination degree of the input tool 2. For example, when the erase function is performed, as an inclination of the input tool 2 from the screen increases (or as the input tool 2 stands up), an area where the erase function is performed may be reduced. On the other hand, as the inclination of the input tool 2 from the screen reduces (or the input tool 2 is laid down), the area in which the erase function is performed may be increased.

Accordingly, the user may feel as if he/she actually erases the sketch by using an eraser. That is, the user may have an experience through the electronic device 100, as if an eraser is actually on an end of a pencil or an area being erased varies depending on an inclination of an eraser with respect to the sketch, and thus, user satisfaction with respect to using the electronic device 100 may be improved.

FIGS. 9A, 9B and 9C are diagrams illustrating examples of switching a function the electronic device 100 is currently executing, according to an example embodiment.

Since FIGS. 9A, 9B and 9C respectively correspond to FIGS. 8A, 8B and 8C, descriptions thereof are omitted here.

In FIG. 9B, if the user wants to perform another function, the user may rotate the input tool 2. Accordingly, the input tool 2 may determine an inclination thereof using a gyro sensor or an acceleration sensor included therein, and transfer information about the inclination to the electronic device 100. Otherwise, the input tool 2 may determine that the input tool 2 is rotated based on the inclination, and may transfer information about the rotation of the input tool 2 to the electronic device 100.

In a case where it is determined that the input tool 2 is rotated, the electronic device 100 may switch the function that is currently being performed into another function by using the input tool 2. Examples of another function are described above with reference to FIG. 8B, and detailed descriptions thereof are omitted.

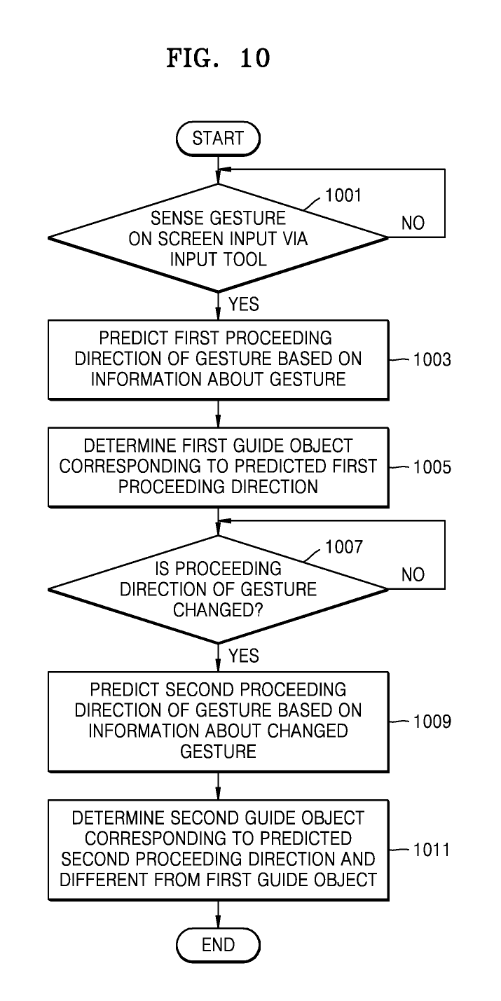

FIG. 10 is a flowchart illustrating an example method of providing guidance to a gesture, according to an example embodiment.

Referring to FIG. 10, in operation 1001, the electronic device 100 may determine whether a gesture input via the input tool 2 is sensed on the screen thereof.

When the gesture is sensed (1001-Y), the electronic device 100 may predict a first proceeding direction of the gesture based on information about the sensed gesture in operation 1003.

In operation 1005, the electronic device 100 may determine a first guide object corresponding to the first proceeding direction predicted in operation 1003. In this case, the electronic device 100 may represent the first guide object on a region corresponding to the first proceeding direction. For example, in a case where a graphic object according to the gesture is previously represented on the screen, the electronic device 100 may represent the first guide object on a region adjacent to the previously represented graphic object in the first proceeding direction.

In operation 1007, the electronic device 100 may determine whether the proceeding direction of the gesture is changed. Changing of the proceeding direction of the gesture may include, for example, a case in which the gesture stops or the gesture moves drawing a curve from a straight line that is previously drawn.

In a case where the proceeding direction of the gesture is changed (1007-Y), the electronic device 100 may predict a second proceeding direction of the gesture based on information about the changed gesture in operation 1009.

In operation 1011, the electronic device 100 may determine a second guide object corresponding to the predicted second proceeding direction, wherein the second guide object is different from the first guide object. In this case, the electronic device 100 may represent the second guide object on a region corresponding to the second proceeding direction that is predicted in operation 1009. For example, in a case where a graphic object according to the changed gesture is previously represented on the screen, the electronic device 100 may represent the second guide object on a region adjacent to the previously represented graphic object in the second proceeding direction.

As an example embodiment, when the proceeding direction of the gesture is a single direction, the first guide object may be an object pointing in a direction, and when the proceeding of the gesture stops, the first guide object may be an object pointing omni-directionally or having no directionality. For example, if the object pointing in a direction is an arrow, the object pointing omni-directionally or having no directionality may be a circular shape object.

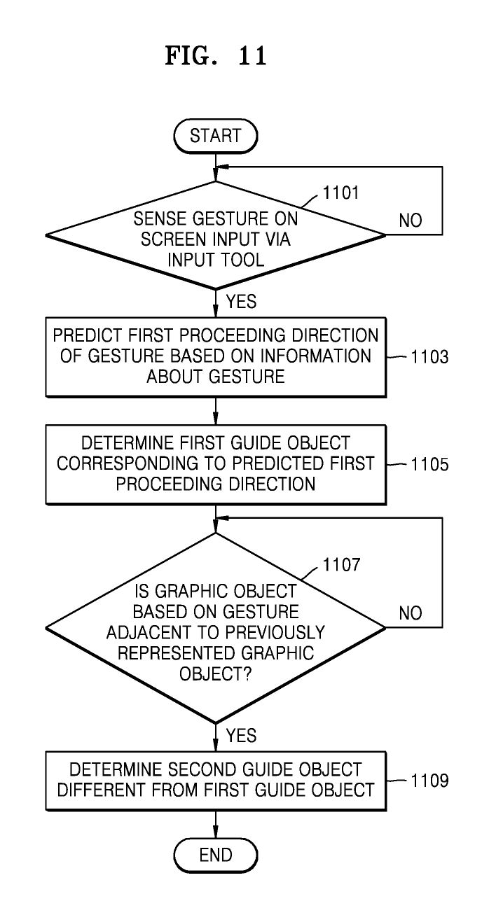

FIG. 11 is a flowchart illustrating an example method of providing guidance with respect to a gesture, according to another example embodiment.

Referring to FIG. 11, in operation 1101, the electronic device 100 may determine whether a gesture input via the input tool 2 on the screen is sensed.

In a case where the gesture is sensed (1101-Y), the electronic device 100 may predict a first proceeding direction of the gesture based on information about the sensed gesture in operation 1103.

In operation 1105, the electronic device 100 may determine a first guide object corresponding to the first proceeding direction predicted in operation 1103. In this case, the electronic device 100 may represent the first guide object on a region corresponding to the first proceeding direction.

In operation 1107, the electronic device 100 may determine whether a graphic object based on the gesture is adjacent to a previously represented graphic object.

If the graphic objects are adjacent to each other (1107-Y), the electronic device 100 may determine a second guide object that is different from the first guide object in operation 1109. In this case, the electronic device 100 may represent at least a part of the second guide object on a region between the graphic object according to the gesture and the graphic object previously represented.

In addition, although it is described all components included in the above embodiments are combined into one component or operate in a combined manner, the scope of the present disclosure is not necessarily limited to the above embodiments. In other words, without departing from the scope of the present disclosure, all the components may also be selectively combined into at least one component and operate. Further, although each of all the components may be implemented as one independent hardware unit, some or all of the components may be selectively combined to be implemented as a computer program having a program module that performs some or all of the functions combined in one or more hardware units. Codes and code segments that comprise the computer program may be easily inferred by one of ordinary skill in the art. The computer program may be stored in a non-transitory computer readable recording medium and may be read and executed by computers to implement the above embodiments.

Here, the non-transitory computer readable recording medium denotes a medium storing data. In detail, the above-described programs may be stored and provided in a non-transitory computer readable recording medium such as a CD, a DVD, a hard disk, a Blue-ray disk, a USB, a memory card, and a ROM.

According to the various example embodiments, since a guide object is provided for guiding the gesture, contact feeling between the graphic object drawn on the screen and the gesture input via the input tool may be improved.

In addition, since a guide object that varies depending on the proceeding direction of the gesture is provided, an error in the drawing operation according to the gesture may be reduced, and accordingly, user's satisfaction of the electronic device may be improved.

In particular, in a case where the electronic device is utilized as a teaching tool and specialized users perform detailed works, a result of drawing may be predicted via the guide object and user satisfaction may be improved.

It should be understood that the various example embodiments described herein should be considered in a descriptive sense only and not for purposes of limitation. Descriptions of features or aspects within each embodiment should typically be considered as available for other similar features or aspects in other embodiments.

While one or more example embodiments have been described with reference to the figures, it will be understood by those of ordinary skill in the art that various changes in form and details may be made therein without departing from the spirit and scope as defined by the following claims.

What is claimed is:

1. A method of guiding a gesture in an electronic device, the method comprising:
sensing a gesture input via an input tool;
predicting a first proceeding direction of the gesture based on information about the gesture;
determining a first guide object corresponding to the predicted first proceeding direction;
predicting a second proceeding direction of the gesture based on information about a changed gesture when a proceeding direction of the gesture is changed; and
determining a second guide object different from the first guide object and corresponding to the predicted second proceeding direction.

2. The method of claim 1, wherein the information about the gesture comprises at least one of: a velocity of the gesture, a trace of the gesture, and an inclination degree and/or an inclination direction of the input tool used to perform the gesture.

3. The method of claim 1, further comprising representing the second guide object on a region corresponding to the predicted second proceeding direction.

4. The method of claim 3, wherein the representing of the second guide object on the region corresponding to the predicted second proceeding direction comprises, representing the second guide object on a region adjacent to the graphic object in the predicted second proceeding direction if a graphic object based on the gesture is previously represented on a screen.

5. The method of claim 1, wherein the change of the proceeding direction of the gesture comprises the gesture being stopped and/or the gesture moving in a straight line being changed to a gesture moving in a curved manner.

6. The method of claim 1, wherein, if the proceeding direction of the gesture is in a single direction, the first guide object is an object pointing in the proceeding direction, and if the gesture stops, the first guide object is an object pointing omni-directionally and/or an object having no directionality.

7. A method of guiding a gesture in an electronic device, the method comprising:
sensing a gesture input via an input tool;
predicting a first proceeding direction of the gesture based on information about the gesture;
determining a first guide object corresponding to the predicted first proceeding direction; and
determining a second guide object that is different from the first guide object when a graphic object based on the gesture is adjacent to a previously represented graphic object.

8. The method of claim 7, further comprising representing at least a part of the second guide object on a region between the graphic object and the previously represented graphic object based on the gesture.

9. An electronic device configured to guide a gesture, the electronic device comprising:
a display configured to provide a screen;
a memory configured to store a first guide object and a second guide object different from the first guide object;
a touch panel configured to sense a gesture input via an input tool; and
a controller configured to control the display to represent a graphic object based on the gesture, to predict a first proceeding direction based on the gesture, to determine the first guide object corresponding to the predicted first proceeding direction of the gesture, to predict a second proceeding direction of the gesture based on information about a changed gesture when a proceeding direction of the gesture is changed, and to determine a second guide object corresponding to the predicted second proceeding direction of the gesture.

10. The electronic device of claim 9, wherein the information about the gesture comprises at least one of: a velocity of the gesture, a trace of the gesture, and an inclination degree and/or an inclination direction of the input tool used to perform the gesture.

11. The electronic device of claim 9, wherein the controller is configured to control the display to represent the second guide object on a region corresponding to the predicted second proceeding direction.

12. The electronic device of claim 11, wherein the controller is configured to control the display to represent the second guide object on a region adjacent to the graphic object in the predicted second proceeding direction.

13. The electronic device of claim 9, wherein the change of the proceeding direction of the gesture comprises the gesture being stopped and/or the gesture moving in a straight line being changed to a gesture moving in a curved manner.

14. The electronic device of claim 9, wherein, the first guide object is an object pointing in the proceeding direction if the proceeding direction of the gesture is in a single direction, and if the gesture stops, the first guide object is an object pointing omni-directionally and/or an object having no directionality.

15. A non-transitory computer readable recording medium having embodied thereon a program, which when executed by a computer, performs operations of a method of claim 1.

16. A non-transitory computer readable recording medium having embodied thereon a program, which when executed by a computer, performs operations of a method of claim 7.
